(19) United States
(12) Patent Application Publication
(10) Pub. No.: US 2014/0268804 A1
(43) Pub. Date: Sep. 18, 2014

(54) SEMI-SPHERE LIGHTING SET WITH CARVING PATTERN BY LASER

(71) Applicant: CHIN-SHENG YANG, Tainan City (TW)

(72) Inventor: CHIN-SHENG YANG, Tainan City (TW)

(21) Appl. No.: 13/802,758

(22) Filed: Mar. 14, 2013

(51) Int. Cl. F21V 3/04

(52) U.S. Cl. CPC F21V 3/049
USPC 362/295; 362/311.06

(57) ABSTRACT

The present invention relates to a semi-sphere lighting set with carving pattern by laser primarily includes a body, which is provided with a circuit disposed inside and a plug disposed at one side for connecting an electricity supply so as to introduce electrical power, an illuminating element, which is disposed at upper side of the body and electrically connected with the circuit of the body, a bottom, which is in transparent form, provided with an orifice and integrated at upper side of the body, and a shell, which is made of transparent plastic material in a hollow semi-sphere form with an opening at one end and a wall having a carving pattern and disposed at outer circumference of the illuminating element as integrated with the bottom. Thus the light generated by the illuminating element is utilized to penetrate the shell so as to produce the enriched and layering visual sensation by the carving pattern of the shell.

### TECHNICAL FIELD OF THE INVENTION

The present invention relates to a lighting set, and particularly to a semi-sphere lighting set with carving pattern made by laser.

### DESCRIPTION OF THE PRIOR ART

Usually an object such as photo frame or toy is placed on top of a desk for decoration in an ordinary life style. Such object has beautiful appearance for static decoration purpose only. Therefore there is a dynamic decoration design that utilizes electricity to rotate an internal decoration for producing the visual sensation. However the dynamic decoration design consumes much electricity. The design for enriching the visual sensation of a decoration object is therefore in need for improvement.

### SUMMARY OF THE INVENTION

The present invention relates to a semi-sphere lighting set with carving pattern by laser primarily includes:

a body that is provided with a circuit disposed inside and a plug disposed at one side for connecting an electricity supply so as to introduce electrical power;
an illuminating element that is disposed at upper side of the body and electrically connected with the circuit of the body;
a bottom that is in transparent form, provided with an orifice and integrated at upper side of the body and adjacent to outer circumference of the illuminating element; and
a shell that is made of transparent plastic material in a hollow semi-sphere form with an opening disposed at one end, has a wall with a carving pattern and is disposed at outer circumference of the illuminating element as integrated with the bottom.

Thus the light generated by the illuminating element is utilized to penetrate the shell so as to produce the enriched and layering visual sensation by the carving pattern of the shell.

### BRIEF DESCRIPTION OF THE DRAWINGS

FIG. 1 is a perspective diagram illustrating a preferred embodiment of the present invention.

FIG. 2 is a perspective decomposition diagram illustrating a preferred embodiment of the present invention.

FIG. 3 is a frontal view illustrating a preferred embodiment of the present invention.

FIG. 4 is a cutaway view illustrating a preferred embodiment of the present invention.

BRIEF DESCRIPTION OF THE DRAWING ELEMENTS

| | | | |
|---|---|---|---|
| 1 | Body | 11 | Circuit |
| 12 | Plug | 13 | Switch |
| 2 | Illuminating element | 3 | Shell |
| 31 | Opening | 32 | Carving pattern |
| 33 | Transparent layer for decoration | 4 | Bottom |
| 41 | Orifice | 5 | Cap |
| 51 | Aperture | 6 | Hanging piece |

### DETAILED DESCRIPTION OF THE PREFERRED EMBODIMENTS

The preferred embodiments of the present invention will be illustrated in detail with reference to FIG. 1, FIG. 2, FIG. 3 and FIG. 4. The diagram and the drawing elements of the preferred embodiments will be explained first.

Please refer to FIG. 1 to FIG. 4. A semi-sphere lighting set with carving pattern by laser of the present invention primarily includes:

a body 1 that is provided with a circuit 11 disposed inside and a plug 12 disposed at one side for connecting an electricity supply so as to introduce electrical power;
an illuminating element 2 that is disposed at upper side of the body 1 and electrically connected with the circuit 11 of the body 1;
a bottom 4 that is in transparent form, provided with an orifice 41 and integrated at upper side of the body 1 with the orifice 41 adjacent to outer circumference of the illuminating element 2; and
a shell 3 that is made of transparent plastic material in a hollow semi-sphere form with an opening 31 disposed at one end, has a wall with a carving pattern 32 and is disposed at outer circumference of the illuminating element 2 as integrated with the bottom 4.

The semi-sphere lighting set with carving pattern by laser of the present invention further includes a cap 5 that is disposed at the top surface of the shell 3 and provided with a hanging piece 6 disposed at the upper side of the cap 5. The hanging piece 6 is a ring-shape spring having two ends individually inserted into two aperture 51 disposed on the cap 5 so as to configure the shell as a hanging decoration object.

With reference to FIG. 4, the body 1 of the preferred embodiment of the present invention is further provided with a switch 13 that has one end connected with the circuit 11 and the other end connected with the illuminating element 2. The switch 13 is to turn the illuminating element 2 on or off. The illuminating element 22 is a incandescent bulb.

The carving pattern 32 can be disposed at either inner or outer wall of the shell 3. The carving of a pattern is made first by a layer of vacuum plating or coating and then by laser to remove the plating or coating at the areas of the pattern so as to make it transparent as compared against other areas of the inner or outer wall. The carving pattern 32 is thus achieved. Further a layer of color can be disposed at the inner wall as enrichment to the carving pattern 32. When the carving pattern 32 is disposed at the outer wall of the shell 3, its inner wall can be provided with a transparent layer for decoration 33 that can be either a mixture of transparent adhesive and sequins or glitter powder or surface treated by grit blasting in order to create the enriched and layering visual sensation.

The carving of a pattern by laser is to utilize a machine using laser beam to carve the surface of an object that different energy and intensity of the laser beam can create different patterns. The laser beam can gasify either plating or coating on the surface of the object for exposing the color of the original material.

It is to be understood that the embodiments of the present invention herein described are merely illustrative for the application of the present invention. Reference herein to details of the illustrated embodiments is not intended to limit the scope of the claims that recite the features regarded as essential to the present invention.

I claim:

1. A semi-sphere lighting set with carving pattern by laser comprising:
a body, provided with a circuit disposed inside said body and a plug disposed at one side of said body for connecting an electricity supply so as to introduce electrical power;
a illuminating element, disposed at upper side of said body and electrically connected with the circuit of said body;
a bottom, in transparent form and provided with an orifice, as integrated at upper side of said body with the orifice adjacent to outer circumference of said illuminating element; and
a shell, made of transparent plastic material in a hollow semi-sphere form with an opening disposed at one end, having a wall with a carving pattern, being disposed at outer circumference of said illuminating element and integrated with said bottom.

2. The semi-sphere lighting set with carving pattern by laser of claim 1, wherein said body is provided with a switch having one end connected to the circuit and the other end connected to said illuminating element so as to turn said illuminating element on or off.

3. The semi-sphere lighting set with carving pattern by laser of claim 1, wherein the carving pattern is disposed at inner wall of said shell.

4. The semi-sphere lighting set with carving pattern by laser of claim 1, wherein the carving pattern is disposed at outer wall of said shell.

5. The semi-sphere lighting set with carving pattern by laser of claim 1, wherein a transparent layer for decoration is provided at inner wall of said shell.

6. The semi-sphere lighting set with carving pattern by laser of claim 1, wherein further includes a cap that is disposed at top surface of said shell and provided with a hanging piece at the upper side of the cap.
